(19) United States
(12) Patent Application Publication
(10) Pub. No.: US 2016/0178829 A1
(43) Pub. Date: Jun. 23, 2016

(54) ONE-SIDED EMISSION TYPE TRANSPARENT LIGHT GUIDE PLATE, AND SURFACE-EMITTING APPARATUS USING THIS LIGHT GUIDE PLATE

(71) Applicant: Kabushiki Kaisha Toshiba, Minato-ku (JP)

(72) Inventors: Hiromichi HAYASHIHARA, Saitama (JP); Hiroshi Ohno, Yokohama (JP); Yuichiro Yamamato, Yokohama (JP); Masataka Shiratsuchi, Kawasaki (JP); Mitsuaki Kato, Kawasaki (JP); Tomonao Takamatsu, Kawasaki (JP)

(73) Assignee: Kabushiki Kaisha Toshiba, Minato-ku (JP)

(21) Appl. No.: 15/044,477

(22) Filed: Feb. 16, 2016

Related U.S. Application Data
(63) Continuation of application No. PCT/JP2014/065109, filed on Jun. 6, 2014.

(30) Foreign Application Priority Data
Aug. 26, 2013 (JP) 2013-175084

(51) Int. Cl. F21V 8/00

(52) U.S. Cl. CPC G02B 6/0043; G02B 6/0058; G02B 6/0063

(57) ABSTRACT

A light guide plate according to an embodiment includes an exit surface where light exits, a rear surface facing this exit surface, and an end face connecting the exit surface and the rear surface. The light guide plate is transparent when no light is entering from the end face. First light scattering means is provided in the rear surface to inwardly reflect the light which has entered from the end face. Second light scattering means is provided in the exit surface to transmit more light than the first light scattering means.

### CROSS-REFERENCE TO RELATED APPLICATION

This application is a Continuation Application of PCT Application No. PCT/JP2014/065109, filed Jun. 6, 2014 and based upon and claiming the benefit of priority from Japanese Patent Applications No. 2013-175084, filed Aug. 26, 2013, the entire contents of all of which are incorporated herein by reference.

### FIELD

Embodiments described herein relate generally to a light guide plate which is transparent at a non-emission time and which emits light on one side at an emission time, and a surface-emitting apparatus using this light guide plate.

### BACKGROUND

Heretofore, an apparatus using a transparent light guide plate has been known as a surface-emitting apparatus which emits light in a surface. If used as the surface-emitting apparatus as it is, the transparent light guide plate can be applied to, for example, a window of a room because the transparent light guide plate becomes transparent when the light is turned off. The use of the transparent light guide plate in the window brings about the following benefits: A wall surface can be provided with an illumination function, the sense of blockage in the room can be reduced, and light can be let in.

There has been known an arrangement of LEDs at the edge of this type of light guide plate such that the light guide plate emits light. The light guide plate is generally configured to have an exit surface and a rear surface, and a white dot pattern to reflect light is provided in the rear surface. According to this configuration, light that has entered from the edge of the light guide plate is reflected by the white dot pattern, and exits (is emitted on one side) from the exit surface.

However, to increase the amount of exit light from the exit surface in the surface-emitting apparatus of the one-sided emission type in which the white dot pattern is provided in the rear surface of the light guide plate, the density of the white dot pattern has to be increased to increase reflectance. This leads to a decrease in the transparency of the light guide plate. On the other hand, it is known that the conventional type of light guide plate causes light to exit from the rear surface as well and therefore has a poor light output ratio (about 70% to 80%).

Patent Literature 1 discloses a backlight unit using a light guide plate in which a base material layer and an exit layer are stacked. A first microstructure pattern which converts the optical path of light guided through the base material layer is formed on the first main surface of the base material layer. A second microstructure pattern which causes the light having the optical path converted by the first microstructure pattern to exit from a second main surface of the exit layer is formed on the second main surface.

However, a reflecting film is disposed on the rear side of this light guide plate. Because the reflecting film is opaque, the light is not transmitted to the rear side of the backlight unit. In other words, this backlight unit does not consider an application in which it requires transmitting properties.

### CITATION LIST

### Patent Literature

Patent Literature 1: Jpn. Pat. Appln. KOKAI Publication No. 2013-97954

As described above, according to the conventional technique, it has been difficult to provide a surface-emitting apparatus which maintains the transparency of the light guide plate and still has a high light emission efficiency.

Therefore, there has been a demand for the development of a light guide plate which has high transparency and a high light emission efficiency, and a surface-emitting apparatus using this light guide plate.

### Solution to Problem

A light guide plate according to an embodiment includes an exit surface where light exits, a rear surface facing this exit surface, and an end face connecting the exit surface and the rear surface. The light guide plate is transparent when no light is entering from the end face. First light scattering means is provided in the rear surface to inwardly reflect the light which has entered from the end face. Second light scattering means is provided in the exit surface to transmit more light than the first light scattering means.

A light guide plate according to another embodiment includes an exit surface where light exits, a reflecting surface facing this exit surface, and an end face connecting the exit surface and the reflecting surface. The light guide plate is transparent when no light is entering from the end face. Light scattering means is provided in the exit surface to transmit at least part of the light which has entered the exit surface at an angle of to be totally reflected by the exit surface out of the light which has entered the light guide plate from the end face.

### BRIEF DESCRIPTION OF THE DRAWINGS

FIG. 1 is an exterior perspective view showing a surface-emitting apparatus using a light guide plate according to an embodiment;

FIG. 2 is an exterior perspective view showing a modification of the surface-emitting apparatus in FIG. 1;

FIG. 3 is a schematic diagram illustrating the function of an exit surface having transparent dots in the surface-emitting apparatus in FIG. 1;

FIG. 4 is a schematic diagram showing a conventional apparatus having no transparent dots in comparison with FIG. 3;

FIG. 5 is a diagram showing a simulation result of calculating a track of light when the surface-emitting apparatus in FIG. 1 is turned on;

FIG. 6 is a diagram showing a simulation result when the conventional apparatus having no transparent dots is turned on in comparison with FIG. 5;

FIG. 7 is a diagram showing the layout of transparent dots in the exit surface of the surface-emitting apparatus in FIG. 1 (upper graph) and the layout of white dots in the reflecting surface of this surface-emitting apparatus (lower graph); and

FIG. 8 is a graph showing light amount ratios when the reflectance and transmittance of each surface of the light guide plate are variously modified, in comparison with light amount ratios in the conventional light guide plate having no transparent dots.

### DETAILED DESCRIPTION

According to one embodiment, a light guide plate includes an exit surface where light exits, a rear surface facing this exit surface, and an end face connecting the exit surface and the rear surface. The light guide plate is transparent when no light is entering from the end face. First light scattering means is provided in the rear surface to inwardly reflect the light which has entered from the end face. Second light scattering means is provided in the exit surface to transmit more light than the first light scattering means.

Various Embodiments will be described hereinafter with reference to the accompanying drawings.

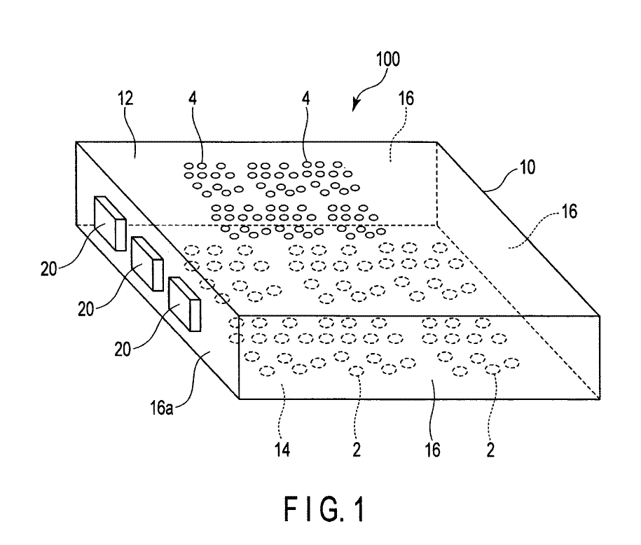

FIG. 1 is an exterior perspective view of a surface-emitting apparatus 100 using a light guide plate 10 according to the embodiment. The surface-emitting apparatus 100 according to the embodiment has the transparent light guide plate 10 and three light sources 20. This surface-emitting apparatus 100 can be used as what is called an illumination apparatus of the one-sided emission type which receives light from each of the light sources 20 via one end face 16a of the light guide plate 10, and repeatedly reflects the light through the light guide plate 10 and thus guides the light to one surface that intersects at right angles with the end face 16a, that is, to an exit surface 12, and then causes the surface-shaped light to exit from the exit surface 12.

For example, if this surface-emitting apparatus 100 is attached to a window of a room, the surface-emitting apparatus 100 can be brought into a no-emitting state and can function as a transparent window during bright daytime, whereas the surface-emitting apparatus 100 can be brought into an emitting state and can function as an illumination apparatus provided on a wall surface during dark nighttime. Alternatively, if the surface-emitting apparatus 100 is attached to the window in such a pose that the exit surface 12 faces to the outside of the room, the surface-emitting apparatus 100 can function as a blindfold board which prevents the room from being visible from the outside in a light emitting state.

This surface-emitting apparatus 100 can also be used as, for example, a backlight of a liquid crystal television or a monitor of a personal computer, and can also be used for purposes other than the illumination apparatus.

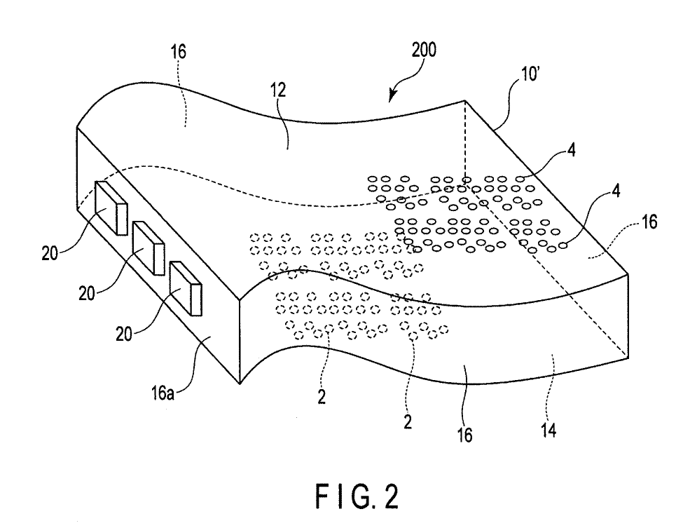

The light guide plate 10 has the exit surface 12, a reflecting surface 14 (rear surface) facing the exit surface 12, and four end faces 16 (16a) which respectively connect four end sides of the exit surface 12 to four end sides of the reflecting surface 14. The light guide plate 10 according to the present embodiment is a rectangular plate-shaped material having a thickness of about 5 mm. Thus, all of the surfaces 12, 14, and 16 are rectangular and flat. However, the shape of the light guide plate is not exclusively the rectangular block shape, and may be any shape that has the exit surface 12 and the reflecting surface 14 facing each other and at least one end face 16 which connects the two surfaces. For example, the exit surface 12 and the reflecting surface 14 do not need to be parallel to each other, and these surfaces 12 and 14 do not always need to be flat. That is, a light guide plate 10′ may be curved as in a surface-emitting apparatus 200 according to a modification shown in FIG. 2. The light guide plate 10 according to the present embodiment and the light guide plate 10′ according to the modification are made of a transparent resin material such as acrylic, but may be made of any transparent material.

The light sources 20 are disposed to face one end face 16a of the light guide plate 10. Although three light sources 20 are provided in alignment at equal intervals in the present embodiment, the number of the light sources 20 has only to be at least one or may be more than one, and can be set to any number in accordance with the intensity of light necessary for the surface-emitting apparatus 100. Although three light sources 20 are provided in one end face 16a of the light guide plate 10 in the case described according to the present embodiment, any number of light sources 20 may be additionally provided in other end faces 16. The light sources 20 are, for example, bare chips of light emitting diodes (LED), and are fixedly connected to the end face 16a so that the optical axes thereof are perpendicular to the end face 16a. However, the light sources 20 are not exclusively the bare chips of the LED, and may be some other point light sources or linear light sources, and any light emitting color of the light sources 20 can be selected.

A large number of circular white dots 2 (scattering dots, first light scattering means) of the same size are provided in the reflecting surface 14 of the light guide plate 10 with a predetermined density distribution (layout). The large number of white dots 2 are provided to scatter part of light transmitted through the reflecting surface 14 and part of light reflected by the reflecting surface 14 and then decrease the transmittance of the light transmitted through the reflecting surface 14 (wasteful light that is not used as illumination light) and increase the reflectance of the light reflected by the reflecting surface 14, and function as non-transmitting light scattering means. That is, the large number of white dots 2 of the reflecting surface 14 function to reflect, toward the exit surface 12, the largest possible amount of light which has entered from the end face 16a of the light guide plate 10.

However, the reflecting surface 14 needs to have a certain degree of light transmittance so that the light guide plate 10 may be transparent in the no-emitting state. Thus, the transmittance and reflectance of light in the reflecting surface 14 need to be set to proper values by adjusting the size and concentration of scattering particles (scatterers) such as white particles (e.g. particles made of titanium oxide) or transparent beads (e.g. particles made of glass) or hollow particles (e.g. particles made of an acrylic resin) enclosed in a binder of the white dots 2, the diameter and thickness of the white dots 2, and/or the density and layout of the white dots 2. The thickness of the white dots 2 according to the present embodiment is adjusted so that the transmittance of the light transmitted through the white dots 2 may be about 25% and so that the reflectance of the light reflected by the white dots 2 may be about 75%.

According to the present embodiment, the large number of white dots 2 are formed on the outer side of the reflecting surface 14 by white silk printing. The diameter of each of the white dots 2 provided in the reflecting surface 14 is about 0.3 mm, and the thickness of each of the white dots 2 is about several ten μm to several hundred μm. Although the optimum layout of the white dots 2 will be described in detail later, an average distance between the white dots 2 is about 0.2 mm. The reflectance of light of the reflecting surface 14 having the white dots 2 is about 70% to 80%, and its transmittance of light is about 20% to 30%. The reflectance and the transmittance change depending on the density of the white dots 2. Although the white dots 2 shown in FIG. 1 and FIG. 2 are made partly larger than actual white dots for easy visibility, the white dots 2 are distributed substantially over the entire reflecting surface 14, and are actually too small to view.

Meanwhile, a large number of circular transparent dots 4 (scattering dots, second light scattering means, light scattering means) smaller in size than the white dots 2 are provided in the exit surface 12 of the light guide plate 10 with a predetermined density distribution (layout). The large number of transparent dots 4 are provided to diffuse the light transmitted through the exit surface 12 and the light reflected by the exit surface 12 so that the transmittance of the light transmitted through the exit surface 12 may be as high as possible and so that the ratio of the light which is not transmitted through the exit surface 12 and reflected back into the light guide plate 10 may be as low as possible. The large number of transparent dots 4 function as light scattering means having transmitting properties.

That is, the large number of transparent dots 4 of the exit surface 12 function to transmit, to the outside of the light guide plate 10 via the exit surface 12 without total reflection, at least part of the light which has entered the exit surface 12 at an angle to be totally reflected by the exit surface 12 out of the light which has entered from the end face 16a of the light guide plate 10. Although the function of the exit surface 12 having the transparent dots 4 will be described in detail later, the large number of transparent dots 4 function to transmit the largest possible amount of light from the exit surface 12.

The transmittance and reflectance of light in the exit surface 12 can also be set to desired values by adjusting the size and concentration of scattering particles (scatterers) such as white particles or transparent beads or hollow particles enclosed in a binder of the transparent dots 4, the diameter and thickness of the transparent dots 4, and/or the density and layout of the transparent dots 4. The thickness of the transparent dots 4 according to the present embodiment is adjusted so that the transmittance of the light may be about 60% and so that the reflectance of the light reflected by the transparent dots 4 may be about 40%.

According to the present embodiment, the large number of transparent dots 4 are formed on the outer side of the exit surface 12 by inkjet printing. The diameter of each of the transparent dots 4 provided in the exit surface 12 is about 0.02 mm, and the thickness of each of the transparent dots 4 is about 1 μm to 5 μm. Although the optimum layout of the transparent dots 4 will be described in detail later, an average distance between the transparent dots 4 is about 0.05 mm. The transmittance of light of the exit surface 12 having the transparent dots 4 is about 50% to 80%, and its reflectance of light is about 20% to 50%. The reflectance and the transmittance change depending on the density of the transparent dots 4. Although the transparent dots 4 shown in FIG. 1 and FIG. 2 are made partly larger than actual transparent dots for easy visibility, the transparent dots 4 are distributed substantially over the entire exit surface 12, and are actually too small to view.

The thickness of the transparent dots 4 is set to about twice to ten times (ten times or less than) the wavelength of the light exiting from the light sources 20. When the light from the light sources 20 is visible light, the wavelength is considered to be about 550 μm. In this case, the thickness of the transparent dots 4 is about 1 μm to 5 μm. In other words, if the thickness of the transparent dots 4 is as small as this, light can be sufficiently transmitted.

All the white dots 2 provided in the reflecting surface 14 and the transparent dots 4 provided in the exit surface 12 are the above-mentioned scattering particles enclosed in the binders. The scattering particles have a diameter of about 0.1 to 10 μm. Although there are no criteria indicating an obvious difference between the white dots 2 and the transparent dots 4, the white dots 2 are higher in light diffusibility than the transparent dots 4, and appear whiter. For example, when the thickness of the binders and the kinds of scattering particles are the same, the scattering particles which are higher in concentration in the binder are higher in light diffusibility and appear whiter. The concentration of the scattering particles referred to here can be represented by the number of scattering particles included in the binder per unit volume. Alternatively, when the kinds and concentration of scattering particles are the same, the light diffusibility can be increased by the increase of the thickness of the binder, and dots that appear whiter can be formed. Although the thickness of the binder is changed to adjust the light diffusibility in the present embodiment, the concentration of the scattering particles may be changed.

The amount of light which had perpendicularly entered a circular region having a diameter of 10 mm in the center of the reflecting surface 14 of the light guide plate 10 according to the present embodiment and transmitted through the light guide plate 10 was checked. The transmittance of light was 71.8%. That is, it was found out that the light guide plate 10 of the surface-emitting apparatus 100 according to the present embodiment had sufficient transparency.

The diameter of the large number of white dots 2 provided in the reflecting surface 14 of the light guide plate 10 is constant (about 0.3 mm). The diameter of the transparent dots 4 provided in the exit surface 12 is also constant (about 0.02 mm). Each dot only has a diameter of about 0.3 mm at the maximum, and is therefore difficult to see with the naked eye. In other words, if the scattering dots 2 and 4 provided in the respective surfaces 12 and 14 of the light guide plate 10 have such a diameter, the transparency of the light guide plate 10 can be maintained.

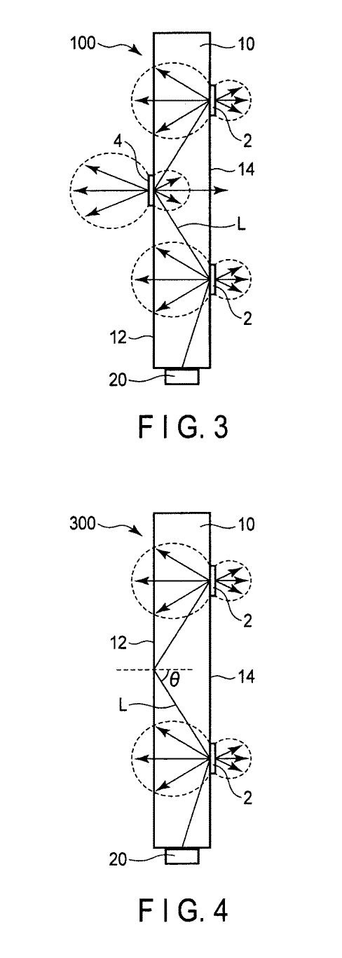

The function of the above-mentioned large number of transparent dots 4 is described here with reference to FIG. 3 and FIG. 4.

FIG. 3 is a sectional schematic view of the surface-emitting apparatus 100 according to the present embodiment cut along a plane that intersects at right angles with the end face 16a in which the light sources 20 are provided. The actual configuration is shown in simplified form, and the sizes of the white dots 2 and the transparent dots 4 that are originally invisible are shown in enlarged form. FIG. 4 is a sectional schematic view showing a conventional surface-emitting apparatus 300 having no transparent dots 4 in the exit surface 12 in comparison with FIG. 3.

Light which has exited from each of the light sources 20 is transmitted through the light guide plate 10 while being respectively reflected by the exit surface 12, the reflecting surface 14, and each of the four end faces 16 (16a). At this point, part of the light transmitted via the light guide plate 10 exits not only from the exit surface 12 of the light guide plate 10 but also from the reflecting surface 14 and the end faces 16 (16a). However, in the surface-emitting apparatus 100 of the one-sided emission type according to the present embodiment, it is important to take the most light from the exit surface 12 of the light guide plate 10.

In particular, attention is paid to the light which is reflected by the white dots 2 of the reflecting surface 14 and then travels to the exit surface 12. In the conventional apparatus shown in FIG. 4, light L which has entered the exit surface 12 at an angle θ to be totally reflected by the exit surface 12 is totally reflected by the exit surface 12 and then returned into the light guide plate 10. In contrast, in the apparatus according to the present embodiment shown in FIG. 3, if the transparent dots 4 exist at the position where this light L that may be totally reflected enters the exit surface 12, the light L is diffused by the transparent dots 4 and is partly transmitted through the exit surface 12 and taken to the outside of the light guide plate 10.

In contrast, at the position where the transparent dots 4 do not exist, the light L that has entered at an angle θ of to be totally reflected is reflected by the exit surface 12 and then returned into the light guide plate 10 as heretofore. The light that has entered the exit surface 12 at an angle less than the angle θ of total reflection is refracted by the exit surface 12 and then taken to the outside of the light guide plate 10 through the exit surface 12. That is, the behavior of the light L is only different in the part of the exit surface 12 in which the transparent dots 4 exist.

That is, if the transparent dots 4 are provided in the exit surface 12, part of the light L that should originally be totally reflected and then returned into the light guide plate 10 can be taken to the outside via the exit surface 12, and the transmittance of the light which is transmitted through the exit surface 12 can be increased accordingly. As a result, the illumination of the light exiting from the exit surface 12 can be higher than the illumination of the light exiting from the reflecting surface 14, and the ratio (hereinafter referred to as a light amount ratio) of the total luminous flux of the light exiting from the exit surface 12 to the total luminous flux of the light exiting from the reflecting surface 14 can be higher. In the present embodiment, the transparent dots 4 are provided in the exit surface 12, so that this light amount ratio can be substantially 2:1.

In contrast, the light amount ratio of the exist side to the reflection side in the conventional light guide plate in which the transparent dots 4 were not provided in the exit surface 12 measured 1.12:1. This showed that the light amount ratio of the exist side to the reflection side of the light guide plate 10 could be increased by the provision of the large number of transparent dots 4 in the exit surface 12 as in the present embodiment. That is, according to the present embodiment, it is possible to provide the surface-emitting apparatus 100 of the one-sided emission type having a high light emission efficiency.

Specifically, the illumination of the light exiting from the exit surface of the conventional light guide plate having no transparent dots was 413 lumens, whereas the illumination of the light exiting from the exit surface 12 of the light guide plate 10 according to the present embodiment having the transparent dots 4 was 564 lumens which was about 37% higher than the conventional illumination. On the other hand, the illumination of the light exiting from the reflecting surface of the conventional light guide plate was 366 lumens, whereas the illumination of the light exiting from the reflecting surface 14 of the light guide plate 10 according to the present embodiment was 290 lumens which was about 21% lower than the conventional illumination. The total light amount in which the amount of the light exiting from the reflecting surface 14 and the amount of the light exiting from the exit surface 12 were added together was 779 lumens in the conventional light guide plate compared to about 854 lumens in the light guide plate 10 according to the present embodiment which was about 10% higher. This showed that the light output ratio was also improved by the provision of the transparent dots 4 in the exit surface 12 of the light guide plate 10.

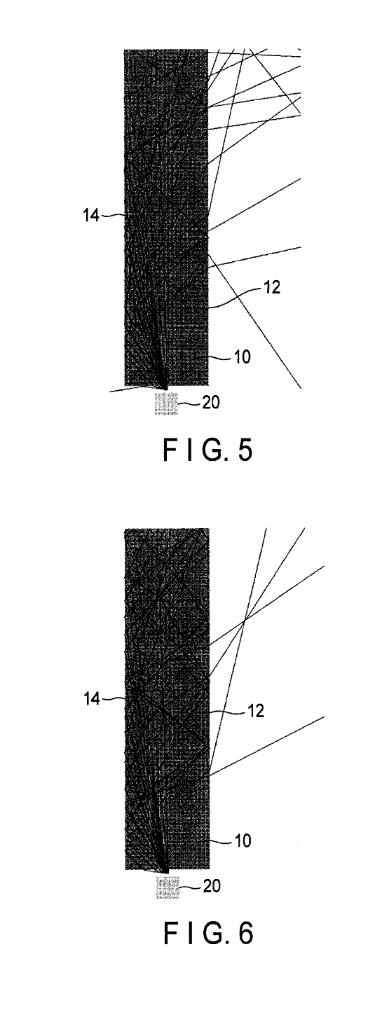

FIG. 5 shows a simulation result of calculating a track of light exiting from the exit surface 12 when the surface-emitting apparatus 100 according to the present embodiment having the transparent dots 4 is turned on under certain conditions. For comparison, FIG. 6 shows a simulation result of calculating a track of light exiting from the exit surface 12 of the conventional surface-emitting apparatus 300 having no transparent dots 4 under the same conditions. This shows that the amount of surface-shaped light that can be taken via the exit surface 12 is larger in the surface-emitting apparatus 100 according to the present embodiment having the transparent dots 4 than in the conventional surface-emitting apparatus 300 having no transparent dots 4.

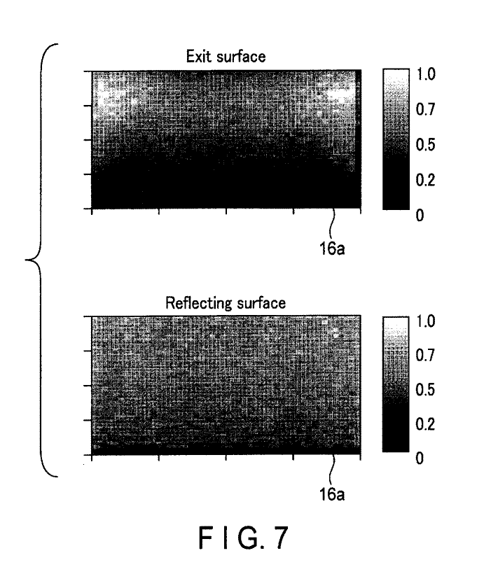

Next, the optimum layout of the white dots 2 and the transparent dots 4 to inhibit uneven luminance in the above-mentioned surface-emitting apparatus 100 is described with reference to FIG. 7.

The surface-emitting apparatus 100 according to the present embodiment is basically higher in luminance on the side closer to the light sources 20 (the end face 16a) and lower in luminance on the side farther from the light sources 20 so that the light from the light sources 20 is received in the light guide plate 10 via one end face 16a. In particular, two peaks of dark parts where luminance is the lowest exist in the vicinity of both ends of the opposite end face 16 which is farthest from the light sources 20. That is, if the light guide plate 10 merely lights, the exit surface-shaped light have uneven luminance.

Thus, in the present embodiment, the white dots 2 provided in the reflecting surface 14 of the light guide plate 10 are laid out as in the lower graph in FIG. 7 and the transparent dots 4 provided in the exit surface 12 of the light guide plate 10 are laid out as in the upper graph in FIG. 7 so that the above-mentioned uneven luminance may be inhibited. In FIG. 7, the white dots 2 and the transparent dots 4 can not be shown in actual size, so that nearly white parts in gray scale are shown as parts having high dot density, and nearly black parts are shown as parts having low dot density.

That is, the large number of white dots 2 provided on the side of the reflecting surface 14 are laid out in the reflecting surface 14 so that the density gradually increases along a direction (first direction; upward direction in the drawing) to vertically depart from the end face 16a in which the light sources 20 are provided. The large number of transparent dots 4 in the exit surface 12 are laid out in the exit surface 12 so that the density gradually increases along the first direction to depart from the end face 16a and so that the density reaches a peak in the vicinity of both ends along a second direction (leftward/rightward direction in the drawing) that intersects with the first direction.

If the white dots 2 are laid out on the side of the reflecting surface 14 as shown, light reflecting performance can be higher on the side farther from the light sources 20 than on the side closer to the light sources 20. Therefore, even if the amount of light transmitted through the light guide plate 10 decreases as the distance from the light sources 20 increases, the amount of surface-shaped light exiting from the exit surface 12 can be corrected to a substantially uniform amount regardless of the distance from the light sources 20. In particular, it is important here to direct the largest possible amount of light exiting from the light sources 20 to the exit surface 12, so that the layout is not designed to eliminate the above-mentioned peaks in two dark parts.

If the above-mentioned layout of the white dots 2 on the side of the reflecting surface 14 is used and then the transparent dots 4 are laid out on the side of the exit surface 12 as shown, uniform surface-shaped light can exit from the whole exit surface 12. That is, on the side of the exit surface 12, uneven luminance that can not be completely corrected on the side of the reflecting surface 14 can be corrected, and the above-mentioned peaks in two dark parts can be eliminated. In particular, the transparent dots 4 of the exit surface 12 are laid out so that the density is the highest in the vicinity of both right and left ends of the end face 16 opposite to the light sources 20 shown in the drawing. Therefore, the transmittance of light in this part can be higher, and dark parts can be obscure accordingly.

That is, in comparison with the conventional light guide plate in which the white dots 2 are only provided in the reflecting surface 14, the transparent dots 4 different in layout from the white dots 2 are provided in the exit surface 12, so that the surface-shaped light exiting from the light guide plate 10 can be more uniform, and moire can be reduced. That is, according to the present embodiment, uneven luminance that can not be completely corrected by the white dots 2 of the reflecting surface 14 can be corrected by the transparent dots 4 of the exit surface 12, and the uneven luminance can be more certainly inhibited.

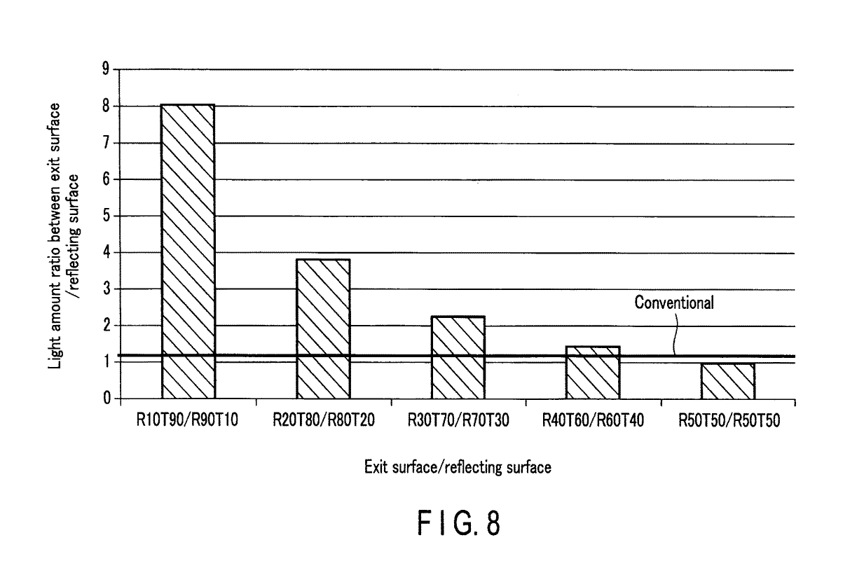

Next, the light amount ratio between the surface-shaped light exiting via the exit surface 12 of the light guide plate 10 and the light exiting via the reflecting surface 14 is considered with reference to FIG. 8. The light amount ratio referred to here indicates the ratio of the total luminous flux of the light exiting via the exit surface 12 to the total luminous flux of the light exiting via the reflecting surface 14.

Here, a light amount ratio is calculated when reflectance R and transmittance T of the white dots 2 provided in the reflecting surface 14 are variously modified and when reflectance R and transmittance T of the transparent dots 4 provided in the exit surface 12 are variously modified. The result is shown in FIG. 8. The level (1.12) of the light amount ratio of the conventional light guide plate in which the transparent dots 4 are not provided in the exit surface 12 is shown for comparison. As described above, the white dots 2 having a light reflectance of 75% and a light transmittance of 25% are provided in the reflecting surface of the conventional light guide plate.

Specifically, when the light amount ratio of the light guide plate 10 (R50T50/R50T50) in which the transparent dots 4 having a reflectance of 50% and a transmittance of 50% were provided in the exit surface 12 and in which the white dots 2 (substantially the same as the transparent dots 4) having a reflectance of 50% and a transmittance of 50% were provided in the reflecting surface 14 was calculated, the light amount ratio of the light guide plate 10 was naturally 1. When the light amount ratio of the light guide plate 10 (R40T60/R60T40) in which the transparent dots 4 having a reflectance of 40% and a transmittance of 60% were provided in the exit surface 12 and in which the white dots 2 having a reflectance of 60% and a transmittance of 40% were provided in the reflecting surface 14 was calculated, the light amount ratio of the light guide plate 10 was about 1.5. When the light amount ratio of the light guide plate 10 (R30T70/R70T30) in which the transparent dots 4 having a reflectance of 30% and a transmittance of 70% were provided in the exit surface 12 and in which the white dots 2 having a reflectance of 70% and a transmittance of 30% were provided in the reflecting surface 14 was calculated, the light amount ratio of the light guide plate 10 was about 2.2. When the light amount ratio of the light guide plate 10 (R20T80/R80T20) in which the transparent dots 4 having a reflectance of 20% and a transmittance of 80% were provided in the exit surface 12 and in which the white dots 2 having a reflectance of 80% and a transmittance of 20% were provided in the reflecting surface 14 was calculated, the light amount ratio of the light guide plate 10 was about 3.9. Furthermore, when the light amount ratio of the light guide plate 10 (R10T90/R90T10) in which the transparent dots 4 having a reflectance of 10% and a transmittance of 90% were provided in the exit surface 12 and in which the white dots 2 having a reflectance of 90% and a transmittance of 10% were provided in the reflecting surface 14 was calculated, the light amount ratio of the light guide plate 10 was about 8.0.

This shows that the light amount ratio is higher in the light guide plate in which the reflectance of the white dots 2 of the reflecting surface 14 is higher and the transmittance of the transparent dots 4 of the exit surface 12 is higher. However, if the reflectance of the white dots 2 of the reflecting surface 14 is too high, the transmittance becomes extremely low, and the transparency of the light guide plate 10 is impaired. Thus, to maintain the transparency of the light guide plate 10, it is necessary to keep a certain degree of high light transmittance in the exit surface 12 and the reflecting surface 14. The minimum transmittance in each surface necessary to maintain the transparency of the light guide plate 10 is considered to be about 50% of the average transmittance at 1 to 10 cm².

As is evident from the calculation results in FIG. 8, if the transparent dots 4 having a transmittance of 60% or more are provided in the exit surface 12, the light amount ratio becomes higher even in, for example, a light guide plate in which the reflectance of the white dots 2 of the reflecting surface 14 is lower (60% or 70%) than that (75%) in the conventional light guide plate, compared to the conventional light guide plate having no transparent dots 4. That is, it is appreciated that the light amount ratio can be higher than in the conventional light guide plate having no transparent dots 4 by the provision of the transparent dots 4 having a transmittance of 60% or more in the exit surface 12.

According to the light guide plate 10 and the surface-emitting apparatus 100 in the embodiment described above, the large number of transparent dots 4 are provided in the exit surface 12, so that it is possible to maintain desired transparency of the light guide plate 10 and then achieve one-sided emission in which surface-shaped light having uniform and sufficient light intensity can exit from the entire exit surface 12, and it is also possible to increase the light output ratio.

Moreover, for example, as in the modification in FIG. 2, the exit surface 12 and the exit surface 12 of the light guide plate 10′ are curved into desired shapes, so that the light guide plate 10′ can be formed into an optimum shape in accordance with the place to install the surface-emitting apparatus 200, and a more compact illumination apparatus having a high degree of freedom in the installation location can be provided.

To further increase the reflectance of the white dots 2, a metal may be evaporated on the rear surfaces of the white dots 2. It is possible to evaporate such a metal as aluminum. In this case, the reflectance of the white dots 2 is about 92%, and its transmittance can be substantially 0%. According to such a configuration, it is possible to further increase the amount of light exiting from the exit surface 12 and further increase the light output ratio.

The embodiment described above has been presented by way of example only, and is not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the white dots 2 and the transparent dots 4 are circular in the embodiment described above, but are not limited to this shape and can be in other shapes such as an elliptical or oval shape. Moreover, the sizes of the white dots 2 provided in the reflecting surface 14 and the transparent dots 4 provided in the exit surface 12 may have margins, and the space between the dots may have a margin.

Furthermore, the surface-emitting apparatus 100 may be provided with a light amount sensor and function to turn on the light when a certain degree of darkness is reached.

1. A transparent light guide plate which comprises an exit surface where light exits, a rear surface facing this exit surface, and an end face connecting the exit surface and the rear surface, the light guide plate comprising:
first light scattering means provided in the rear surface to reflect, by the rear surface, the light which has entered from the end face; and
second light scattering means provided in the exit surface to transmit more light than the first light scattering means.

2. The light guide plate according to claim 1, wherein
each of the first and second light scattering means comprises scattering dots in which scatterers are enclosed.

3. The light guide plate according to claim 2, wherein
the concentration of the scatterer included in each of the scattering dots of the second light scattering means is lower than the concentration of the scatterer included in each of the scattering dots of the first light scattering means.

4. The light guide plate according to claim 2, wherein
the size of the scattering dots of the second light scattering means is smaller than the size of the scattering dots of the first light scattering means.

5. The light guide plate according to claim 2, wherein
the thickness of the scattering dots of the second light scattering means is smaller than the thickness of the scattering dots of the first light scattering means.

6. The light guide plate according to claim 2, wherein
the scattering dots of the first light scattering means are laid out so that the density gradually increases as the distance increases from the end face along a first direction, and
the scattering dots of the second light scattering means are laid out so that the density increases as the distance increases from the end face along the first direction and so that the density reaches a peak on both sides along a second direction that intersects with the first direction.

7. The light guide plate according to claim 6, wherein
the scattering dots of the first light scattering means have the same size, and the scattering dots of the second light scattering means have the same size which is smaller than that of the scattering dots of the first light scattering means.

8. The light guide plate according to claim 5, wherein
the thickness of the scattering dots of the second light scattering means is ten times or less than the wavelength of visible light.

9. The light guide plate according to claim 1, wherein
the transmittance of light transmitted through the exit surface in which the second light scattering means is provided is 60% or more.

10. A transparent light guide plate which comprises an exit surface where light exits, a reflecting surface facing this exit surface, and an end face connecting the exit surface and the reflecting surface, the light guide plate comprising:
light scattering means provided in the exit surface to transmit at least part of the light which has entered the exit surface at an angle of to be totally reflected by the exit surface out of the light which has entered the light guide plate from the end face.

11. A surface-emitting apparatus comprising:
the light guide plate according to claim 1; and
a light source disposed to face the end face of the light guide plate.

12. A surface-emitting apparatus comprising:
the light guide plate according to claim 2; and
a light source disposed to face the end face of the light guide plate.

13. A surface-emitting apparatus comprising:
the light guide plate according to claim 3; and
a light source disposed to face the end face of the light guide plate.

14. A surface-emitting apparatus comprising:
the light guide plate according claim 4; and
a light source disposed to face the end face of the light guide plate.

15. A surface-emitting apparatus comprising:
the light guide plate according claim 5; and
a light source disposed to face the end face of the light guide plate.

16. A surface-emitting apparatus comprising:
the light guide plate according to claim 6; and
a light source disposed to face the end face of the light guide plate.

17. A surface-emitting apparatus comprising:
the light guide plate according to claim 7; and
a light source disposed to face the end face of the light guide plate.

18. A surface-emitting apparatus comprising:
the light guide plate according to claim 8; and
a light source disposed to face the end face of the light guide plate.

19. A surface-emitting apparatus comprising:
the light guide plate according to claim 9; and
a light source disposed to face the end face of the light guide plate.

20. A surface-emitting apparatus comprising:
the light guide plate according to claim 10; and
a light source disposed to face the end face of the light guide plate.
